(19) United States
(12) Patent Application Publication
(10) Pub. No.: US 2018/0324438 A1
(43) Pub. Date: Nov. 8, 2018

(54) METHOD, DEVICE, AND COMPUTER-READABLE MEDIUM FOR COMPRESSING IMAGE

(71) Applicant: abenecel Inc., Seoul (KR)

(72) Inventor: Jun Ky KWAK, Seoul (KR)

(73) Assignee: abenecel Inc., Seoul (KR)

(21) Appl. No.: 16/019,324

(22) Filed: Jun. 26, 2018

Related U.S. Application Data
(63) Continuation of application No. PCT/KR2017/004517, filed on Apr. 27, 2017.

(30) Foreign Application Priority Data
Jun. 15, 2016 (KR) 10-2016-0074366
Sep. 1, 2016 (KR) 10-2016-0112322

(51) Int. Cl. H04N 19/14; H04N 19/119; H04N 19/176; G06T 5/00; G06T 5/20

(52) U.S. Cl. CPC H04N 19/14; H04N 19/119; G06T 5/20; G06T 5/003; H04N 19/176

(57) ABSTRACT

The present invention relates to a method of compressing an image, for maintaining an image format, and providing an image having a high compressibility while minimizing image quality degradation for an original image regardless of the image format. The method of compressing an image embodied in a computing device according to an embodiment of the present invention includes: a file format determination step of determining whether a file format of an original image is a lossy compressed image, a lossless compressed image, or an uncompressed image; an image block division step of dividing the original image into a plurality of image blocks; and an image conversion step of converting the original image in a different manner according to the file format of the original image.

### CROSS-REFERENCE TO RELATED APPLICATIONS

The present application is a continuation of International Patent Application No. PCT/KR2017/004517 filed Apr. 27, 2017, which is based upon and claims the benefit of priority to Korean Patent Application Nos. 10-2016-0074366 filed Jun. 15, 2016 and 10-2016-0112322 filed Sep. 1, 2016. The disclosures of the above-listed applications are hereby incorporated by reference herein in their entirety.

### BACKGROUND OF THE INVENTION

### 1. Field of the Invention

The present invention relates to a method of compressing an image, a device thereby and a computer program therefor, and more particularly, to a method of compressing an image, a device thereby and a computer program therefor, for minimizing image quality degradation for an original image regardless of an image format, maintaining a codec or the image format, and providing a compressed image having a high compressibility.

### 2. Description of the Related Art

In a modern society, computers and computer networks enable tremendous amounts of information to be transmitted between computers and between computers and storage devices.

When a computer accesses a local storage device, such as a local hard drive and a local floppy drive, tremendous amounts of data are quickly accessed.

However, when data at a remote storage location is accessed via wide area network (WAN), Internet, a wireless communication channel (such as a cellular phone network), the data transmitting speed is significantly reduced.

Accordingly, a lot of time to transmit large files are required.

Further, an expensive and limited storage space is required for storing the large files.

In general, because an image requires information about each pixel in the image, photographic images or similar graphic images are considered as large files.

Accordingly, the photographic image or the similar graphic image requires a storage space of 1 megabyte (MB) or more, and requires a considerable transmission time when transferred through a communication network having low transmission rate.

Accordingly, in recent years, many protocols and standards for compressing images have been developed in order to reduce the amount of the storage space required to store the images and reduce the transmission time.

An image compression method is divided into a lossy compression method and a lossless compression method.

The compression method compresses the image by removing spatial, temporal, and stochastic redundancies.

Particularly, whereas the lossy compression method causes a deterioration due to loss of original data, the lossless compression method can accurately reproduce the original image after decoding.

Meanwhile, usual video file requires tens of MBs or more of the storage space, requires a considerable transmission time when transmitted through a communication network having low transmission rate.

Accordingly, in recent years, many protocols and standards for compressing images have been developed in order to reduce the amount of the storage space required to store the videos and reduce the transmission time.

### SUMMARY OF THE INVENTION

The present invention provides a method of compressing an image, a device thereby and a computer program therefor, for minimizing image quality degradation for an original image regardless of an image format, maintaining a codec or the image format, and providing a compressed image having a high compressibility.

To solve the above problem, an embodiment of the present invention provides the method of compressing an image embodied in a computing device, which includes: a file format determination step of determining whether a file format of an original image is a lossy compressed image, a lossless compressed image, or an uncompressed image; an image block division step of dividing the original image into a plurality of image blocks; and an image conversion step of converting the original image in a different manner according to the file format of the original image.

According to some embodiments, in the image conversion step, the conversion is performed by using at least two different manners depending on whether the original image is compressed and whether the original image is lossy if compressed, and one of the at least two converted images may be selected as a final compressed image, or one of at least two compressed images of the at least two converted images may selected as the final compressed image.

According to some embodiments, in the image conversion step, the compression method of the compressed image may correspond to the compressed type of the original image.

According to some embodiments, in the image conversion step, the complexity or the number of colors of the image block of the original image is determined, so that a different image processing may be performed for each image block.

According to some embodiments, in the image conversion step, when the original image is a lossy compressed image or a lossless compressed image, the original image is converted by using at least two manners so as to generate at least two converted images, lossy or lossless compression is performed on the converted images so as to generate at least two compressed images, and an image having a smaller volume among the at least two compressed images may be selected as the final compressed image.

According to some embodiments, in the image conversion step, when the original image is an uncompressed image, the original image is converted by using at least two manners so as to generate at least two converted images, lossless compression is performed on the converted images so as to generate at least two compressed images, and a corresponding compressed image having a smaller volume among the at least two converted images may be selected as the final compressed image.

According to some embodiments, in the image conversion step, when the original image is a lossy compressed image, the complexity is determined for each image block of the original image, and blur-processing is performed for each image block according to the complexity, so as to generate a first converted image.

According to some embodiments, in the image conversion step, when the original image is a lossy compressed image, blur-processing is performed on the original image, an edge area of the original image is extracted, and an original area of the preprocessed image is combined with an area corresponding to the edge area in the original image which is blur-processed so as to generate a second converted image.

According to some embodiments, in the image conversion step, when the original image is a lossy compressed image, the complexity is determined for each image block of the original image, and blur-processing is performed for each image block according to the complexity so as to generate a first converted image; and blur-processing is performed on the original image, an edge area of the original image is extracted, and an original area of the preprocessed image is combined with an area corresponding to the edge area in the original image which is blur-processed so as to generate a second converted image, so that one of the first converted image and the second converted image or one compressed image may be determined as the final compressed image.

According to some embodiments, in the image conversion step, when the original image is a lossless compressed image or an uncompressed image, the number of colors is determined for each image block of the original image, and a different dithering processing is performed on each image block according to the number of colors so as to generate a first converted image.

According to some embodiments, in the image conversion step, when the original image is a lossless compressed image or an uncompressed image, the complexity is determined for each image block of the original image, and a different dithering processing and a blur-processing are performed for each image block according to the complexity so as to generate a second converted image.

According to some embodiments, in the image conversion step, when the original image is a lossless compressed image or an uncompressed image, the number of colors is determined for each image block of the original image, a different dithering processing is performed for each image block according to the number of colors so as to generate a first converted image, the complexity is determined for each image block of the original image, and a different dithering processing and a blur-processing are performed for each image block according to the complexity so as to generate a second converted image, so that one of the first converted image and the second converted image or one compressed image may be determined as the final compressed image.

According to some embodiments, in the image conversion step, when the original image is a lossy compressed image, the complexity is determined for each image block of the original image, and a different image processing is performed for each image block according to the complexity. When the original image is a lossless compressed image or an uncompressed image, the number of colors is determined for each image block of the original image, and a different image processing is performed for each image block according to the number of colors.

To solve the above problem, an embodiment of the present invention provides a computer-readable medium which stores instructions for allowing a computing device to perform the following steps including: a file format determination step of determining whether a file format of an original image is a lossy compressed image, a lossless compressed image, or an uncompressed image; an image block division step of dividing the original image into a plurality of image blocks; and an image conversion step of converting the original image in a different manner according to the file format of the original image.

To solve the above problem, an embodiment of the present invention provides a computing device including at least one processor and at least one memory for compressing an original image, which may include: a file format determination unit for determining whether a file format of an original image is a lossy compressed image, a lossless compressed image, or an uncompressed image; an image block division unit for dividing the original image into a plurality of image blocks; and an image conversion unit for converting the original image in a different manner according to the file format of the original image.

According to an embodiment of the present invention, even if a PDF, JPEG, or PNG file format image file is stored, the file can be optimized so that image quality is similar and a file size is similar or smaller, compared to an existing JBIG, TIFF, or JPEG 2000 file format image file.

According to an embodiment of the present invention, when the PDF, JPEG, or PNG file is used, the file can be used without any change in a standard web environment based on HTML5 instead of a separate dedicated client/server environment.

According to an embodiment of the present invention, even if the image is stored in the JBIG, TIFF, or JPEG 2000 file format, additional compression can be performed up to 30% to 50%.

According to an embodiment of the present invention, because the existing image files are additionally compressed, storage costs and network costs can be reduced.

According to an embodiment of the present invention, because the image is preprocessed, an existing encoder can be used without any change. In addition, a dedicated encoder can be produced to improve performance if necessary.

### BRIEF DESCRIPTION OF THE DRAWINGS

FIG. 1 is a view schematically showing an optimizing process of an original image according to an embodiment of the present invention.

FIG. 2 is a view schematically showing an internal configuration of a computing device for optimizing an image according to an embodiment of the present invention.

FIG. 3 is a view schematically showing an internal configuration of a preprocessing unit according to an embodiment of the present invention.

FIGS. 4A and 4B are views illustrating images which are noise-canceled according to an embodiment of the present invention.

FIG. 5 is a view schematically showing an internal configuration of an image compression unit according to an embodiment of the present invention.

FIG. 6 is a view schematically showing operations of a file format determination unit according to an embodiment of the present invention.

FIGS. 7A, 7B and 7C are views illustrating image blocks according to an embodiment of the present invention.

FIG. 8 is a view schematically showing an internal configuration of an image conversion unit according to an embodiment of the present invention.

FIG. 9 is a view schematically showing operations of an image conversion unit in the case of a lossy compressed image according to an embodiment of the present invention.

FIG. 10 is a view schematically showing operations of an image conversion unit in the case of a lossless compressed image according to an embodiment of the present invention.

FIG. 11 is a view schematically showing operations of an image conversion unit in the case of an uncompressed image according to an embodiment of the present invention.

FIG. 12 is a view schematically showing steps of a method for optimizing a document image according to an embodiment of the present invention.

FIG. 13 is a view schematically showing sub steps of a preprocessing step according to an embodiment of the present invention.

FIG. 14 is a view schematically showing sub steps of a block processing step according to an embodiment of the present invention.

FIG. 15 is a view schematically showing sub steps of an image compressing step according to an embodiment of the present invention.

FIG. 16 is a view schematically showing sub steps of an image conversion step in the case of a lossy compressed image according to an embodiment of the present invention.

FIG. 17 is a view schematically showing sub steps of an image conversion step in the case of a lossless compressed image according to an embodiment of the present invention.

FIG. 18 is a view schematically showing sub steps of an image conversion step in the case of an uncompressed image according to an embodiment of the present invention.

### DETAILED DESCRIPTION

Hereinafter, various embodiments and/or aspects will be described with reference to the drawings. In the following description, multiple specific details are set forth in order to provide an overall understanding of one or more aspects for the purpose of explanation. However, it will also be appreciated by those having ordinary skill in the art that such aspect(s) may be carried out without the specific details. The following description and accompanying drawings will be set forth in detail specific illustrative aspects of one or more aspects. However, the aspects are merely illustrative and some of various ways among principles of the various aspects may be employed, and the description set forth herein is directed to include all of the aspects and the equivalent thereof.

In addition, various aspects and features will be presented by a system that may include multiple devices, components and/or modules, and the like. It also shall be noted and understood that various systems may include additional devices, components and/or modules, and/or may not include all of the devices, components, modules, and the like discussed in connection with the drawings.

Any aspect or design described with respect to the terms “embodiment”, “example”, “aspect” and the like may be considered as preferable or advantageous over other aspects or designs. The terms ‘unit’, ‘component’, ‘module’, ‘system’, ‘interface’ and the like used in the following generally refer to a computer-related entity such as hardware, a combination of hardware and software, or software.

In addition, the terms “comprises” “comprising”, “include”, and/or “including” signifies the presence of the corresponding feature and/or component, however, does not exclude the presence or addition of one or more other features, components, and/or groups thereof.

In addition, the terms including an ordinal number such as first and second may be used to describe various elements, however, the elements are not limited by the terms. The terms are used only for the purpose of distinguishing one element from another element. For example, the first element may be referred to as the second element without departing from the scope of the present invention, and similarly, the second element may also be referred to as the first element. The term “and/or” includes any one of a plurality of related listed items or a combination thereof.

In addition, unless otherwise defined in embodiments of the present invention, all terms used herein including technical or scientific terms have the same meaning as commonly understood by those having ordinary skill in the art. Terms such as those defined in generally used dictionaries should be interpreted to have the meaning consistent with the meaning in the context of the related art, and it should not be interpreted as an ideal or excessively formal meaning unless expressly defined in embodiments of the present invention.

Document Image Optimization System

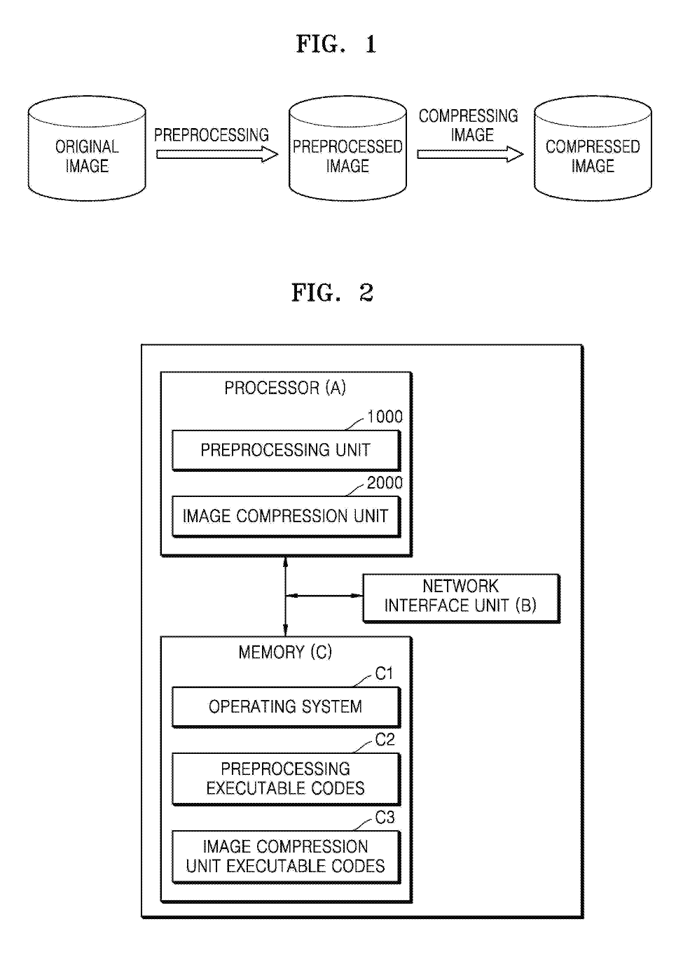

FIG. 1 is a view schematically showing a method of optimizing a document image according to an embodiment of the present invention.

According to the embodiment, a preprocessing step S100 of generating a preprocessed image is performed by removing noise from an original image and sharpening a text. In the preprocessing step, at least one of sharpening process, binarizing process, and blurring process may be performed among image processing techniques. The preprocessing step S100 is performed so that the original image may be converted into the preprocessed image, and the preprocessed image may be increased in sharpness of the text in a document image.

Herein, the original image includes the document image, and is not limited to an image file format.

The term “document image” herein generally refers to an image containing a text, but it is not limited thereto, and the document image includes all kinds of file format images regardless of file format and text inclusion, such as an image scanned or photographed by a smart phone, a scanner, and a camera, an image preliminarily image-processed on the image, and an images created in a digital way.

In addition, the method of optimizing a document image according to the present invention may further include an image compression step of performing an image compression on the preprocessed image. In this case, the additional image processing, in other words, the image compression is performed on the preprocessed image, so that the volume of the document image may be reduced.

Preferably, in the image compression step, compression is performed by using different manners depending on whether the preprocessed image is compressed and whether the preprocessed image is lossy if compressed. Herein, whether the preprocessed image is compressed and whether the preprocessed image is lossy if compressed is basically determined according to whether the original image is compressed and whether the original image is lossy if compressed. In the above manner, each different type of original image can be optimized as a document image without changing the file format of the original image.

In addition, the compression is performed with considering whether the original image is compressed and whether the original image is lossy if compressed, so that the volume can be reduced while minimizing an image quality degradation of the original image or the preprocessed image.

In addition, because the image compression step is performed after the preprocessing step is performed, the image can be optimized while maintaining the effect in the image compression step.

Hereinafter, a device for optimizing an image will be described according to the present invention.

FIG. 2 is a view schematically showing an internal configuration of a computing device for optimizing a document image according to an embodiment of the present invention.

The computing device for optimizing the document image according to an embodiment of the present invention may include a processor, a bus (corresponding to the bidirectional arrows between a processor, a memory, and a network interface unit), a network interface and a memory. The memory C may include an operating system C1, a preprocessing unit executable code C2, and an image compressing unit executable code C3. The processor may include a preprocessing unit 1000 and an image compression unit 2000. In other embodiments, the computing device for optimizing a document image may include more components than the components shown in FIG. 2.

The memory is a computer-readable recording medium, and may include a permanent mass storage device such as a random access memory (RAM), a read only memory (ROM), and a disk drive. In addition, program codes for the operating system C1, the preprocessing unit executable code C2, and the image compression unit executable code C3 may be stored in the memory. Those software components may be loaded from a recording medium which is readable in an additional computer other than the memory by using a drive mechanism (not shown). The recording medium which is readable in an additional computer may include a computer-readable recording medium (not shown) such as a floppy drive, a disk, a tape, a DVD/CD-ROM drive, and a memory card. In another embodiment, the software components may be loaded into the memory via a network interface unit B instead of the computer-readable recording medium.

The bus may be configured by using a high-speed serial bus, a parallel bus, a storage area network (SAN), and/or other suitable communication technology. The network interface unit B may be a computer hardware component for connecting the computing device for optimizing a document image to a computer network.

The network interface B may connect the computing device for optimizing a document image to the computer network via a wireless or wired connection. The bus may enable communication and data transfer between components of the computing device for optimizing a document image. Through the above network interface unit B, the computing device for optimizing a document image may be connected to a tactile interface device in a wireless or wired manner.

The processor may be configured to process instructions of a computer program by performing input/output operations of the computing device for optimizing a basic arithmetic and logic, and a document image. The instructions may be provided to the processor by the memory or the network interface unit B and through the bus. The processor may be configured to execute program codes for the preprocessing unit 1000, and the image compression unit 2000. The above program codes may be stored in a recording device such as a memory.

The preprocessing unit 1000 and the image compression unit 2000 may be configured to perform the method, which will be described below, of optimizing a document image. The above-mentioned processor may omit some components, further include additional components not shown, or be combined with at least two components, according to the method of optimizing a document image.

Meanwhile, the computing device preferably includes a personal computer or a server. In some cases, the computing device includes a smart phone, a tablet, a mobile phone, a videophone, an e-book reader, a desktop PC, a laptop PC, a netbook PC, a personal digital assistant (PDA), a portable multimedia player (PMP), an MP3 player, a mobile medical device, a camera, a wearable device (for example, a head-mounted device (HMD)), an electronic clothing, an electronic bracelet, an electronic necklace, an electronic appcessory, an electronic tattoo, a smart watch or the like.

The computing device may optimize the image received by connected or built-in scanner, camera, or the like by performing processes of the preprocessing unit 1000 and the image compression unit 2000, or may optimize the image by performing the processes of the preprocessing unit 1000 and the image compression unit 2000 with respect to the image transmitted through the network interface unit B from the outside or the image already stored in the memory C.

Alternatively, when the computing device is a server, the preprocessing unit 1000 and the image compression unit 2000 may perform an image optimization with respect to the image received through the network interface unit B, and the optimized image may be transmitted to the user through the network interface unit.

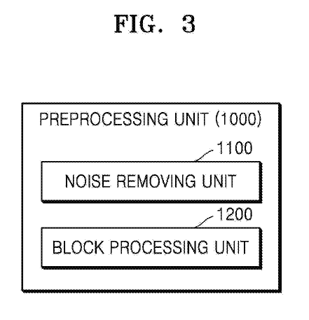

FIG. 3 is a view schematically showing an internal configuration of the preprocessing unit 1000 according to an embodiment of the present invention.

The preprocessing unit 1000 performs at least one of shading processing, binarizing processing, and blur-processing on the original image, thereby performing operations configured to remove noise from the original image and sharpen a text.

The sharping process is performed to make the image more clear. When the sharpening process is performed on a document image, only the text part may be more clear and distinct. One example of the sharpening process is to clearly the image while increasing the contrast of an edge portion of each pixel having a different color value. When the sharpening process is performed, a bright portion becomes lighter and a dark portion becomes darker at one pixel of a boundary area having lateral different colors, so that the original image may become clearer. Meanwhile, in general, the sharpening process may be performed using any of the known algorithms for the sharpening process.

The blur-process is performed to blur the image. Meanwhile, in general, the blur-process may be performed using any of the known algorithms for the blur-process. More preferably, the blur-process includes a Gaussian blur-process.

The binarizing process corresponds to a technique of binarizing an image. Meanwhile, in general, the binarizing process may be performed using any of the known algorithms for the binarizing process. Preferably, the binarizing process is a threshold binarizing process for converting an image into a gray image, and performing a binarization based on a specific value of the gray image. More preferably, the binarizing process is an adaptive threshold binarizing process for variably binarizing the image by using values of surrounding pixels.

As shown in FIG. 3, the preprocessing unit 1000 include: a noise removing unit 1100 for performing a sharpening process and a binarizing process on an original image; and a block processing unit 1200 for dividing the original image subjected to the noise removal step S110 into image blocks, and performing different processes with respect to an image block including a text and an image block not including a text, Preferably, the noise removing unit 1100 performs a sharpening process on the original image in advance, and then performs the binarizing process on the original image in the adaptive threshold manner.

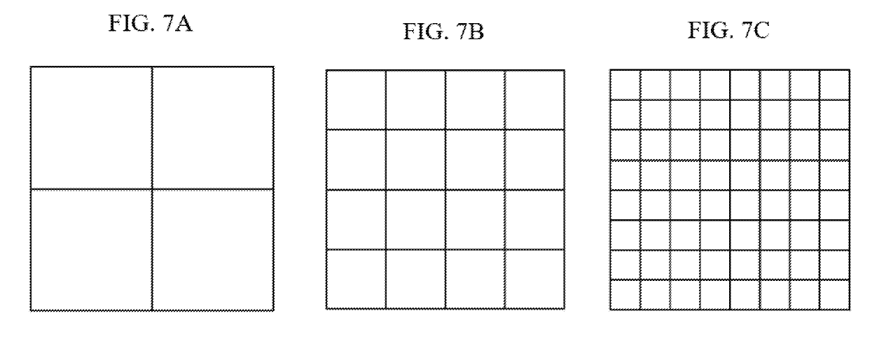

Preferably, the block processing unit 1200 primarily divides the original image into image blocks. The image block, as shown in FIGS. 7A, 7B and 7C, refers to each image defined by a plurality of block areas, and will be described later. Meanwhile, after the image is divided into image blocks, a feature of each image block is distinguished, and different image processing may be performed for each of the image blocks according to the distinguished result.

Preferably, the block processing unit 1200 determines whether a text is included in each image block. In order to determine whether the text is included, the black pixel density of the image block is measured, and it is determined as an image block including the text when the image block has high density of the black pixel. Alternatively, adjacent pixel groups continuously connected in the image block are labeled, and a straight linear length or a diagonal length of the labeled group is measured, such that a presence of the text is determined based on a histogram for the length. Alternatively, a text extraction algorithm is performed on the image block to determine whether the text is extracted. Alternatively, a statistical histogram for the image block is outputted to determine the similarity with the histogram when the text is included.

Then, the block processing unit 1200 performs blur-process on the image block including the text, and performs additional sharpening process on the image block not including the text.

According to the above configuration, blur-process or sharpening process are additionally performed for each area defined as the image block with respect to the entirely shaded and binarized original image. Accordingly, when image block contains a text, sharpening process, binarizing process, sharpening process are sequentially performed. When image block does not contain a text, sharpening process, binarizing process, blur-process are sequentially performed. As described above, one image is divided into image blocks, and different additional image processing is performed depending on whether text is included in each image block, so that the document image can be converted more clearly, and the volume of the image can be reduced in the image compression unit 2000, which will be described later, without deteriorating the quality.

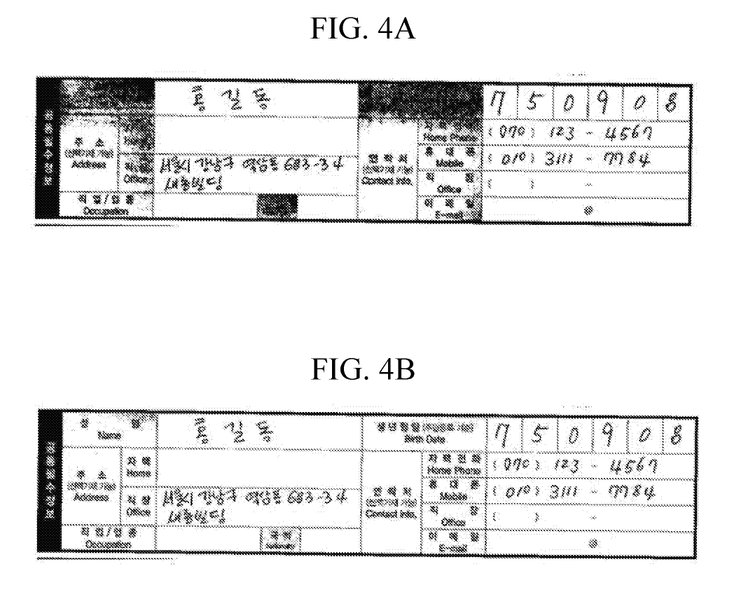

FIGS. 4A and 4B are views illustrating images which are noise-canceled according to an embodiment of the present invention.

FIG. 4A shows a partial area of the document image scanned by a usual scanner. On the contrary, FIG. 4B shows a partial area sharpened and binarized by the adaptive threshold manner.

In FIG. 4B, it is found that the initial noises and recognition uncertainty upon print by the scanner is significantly removed by operations of the noise removing unit 1100. In addition, when the block processing unit 1200 image-processes each image block unit, the clearer document image can be obtained.

Image Compression System

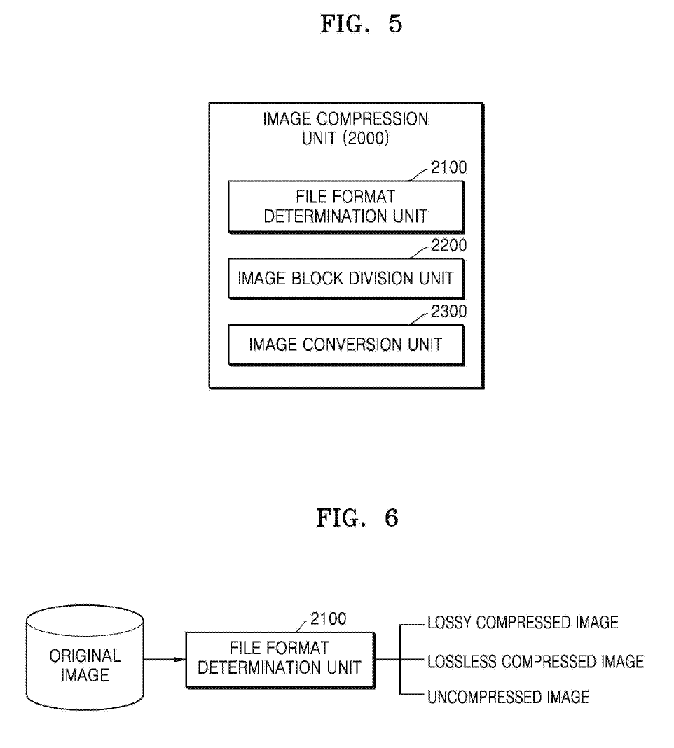

FIG. 5 is a view schematically showing an internal configuration of an image compression unit 2000 according to an embodiment of the present invention. For convenience, hereinafter, the operations or the image compression step of the image compression unit will be described as a subsequent process of the preprocessed image preprocessed by the preprocessing unit 1000. However, the present invention is not limited thereto, and includes an embodiment in which the image compression unit 2000 independently compresses an image to which the preprocessing is not performed (hereinafter referred to as “original image” for convenience).

The image compression unit 2000 shown in FIG. 5 performs operations of optimizing the volume of the image while minimizing the deterioration of image quality in the preprocessed image preprocessed by the preprocessing unit 1000. Alternatively, the image compression unit 2000 performs operations of optimizing the volume of the image while minimizing the deterioration of image quality with respect to the original image inputted by the user.

Specifically, the image compression unit 2000 include: a file format determination unit 2100 for determining whether a file format of the preprocessed image or the original image is a lossy compressed image, a lossless compressed image, or an uncompressed image; an image block division unit 200 for dividing the preprocessed image into a plurality of image blocks; and an image conversion unit 2300 for converting the preprocessed image or the original image in a different manner according to file formats of the preprocessed image or the original image.

The above image compression unit 2000 does not perform the conversion (compression) in the same manner for all preprocessed images or original images, but determines whether the preprocessed image or the original image is compressed, and whether the preprocessed image or the original image is lossy if compressed, and the preprocessed image is converted in a different manner according to the determination, so that each image can be individually optimized. Herein, with respect to the preprocessed image, the compressed state and the lossy state if compressed are usually determined by the original image before preprocessing.

In addition, when performing the image conversion, the image compression unit 2000 does not perform the image conversion in the same way for the entire area of the image, but divides the image into a plurality of image blocks, and performs the image conversion in a different way according to characteristics of each image block, so that each image can be converted in a manner optimized for each portion of the image block.

More preferably, the image compression unit 2000 performs the conversion by using at least two different manners depending on whether the preprocessed image is compressed and whether the preprocessed image is lossy if compressed. One of the at least two converted images may be selected as a final compressed image, or one of at least two compressed images of the at least two converted images is selected as a final compressed image.

For example, in the image compression step S200, when the image is a lossy compressed image, the image is converted by using a method A and a method B; when the image is a lossless compressed image, the image is converted by using a method C and a method D; and when the image is an uncompressed image, the image is converted by using a method E and a method F.

Then, the compressed image having a smaller volume between the two compressed images subjected to the lossy or lossless compression again with respect to the images converted in two manners is selected as the final compressed image, the converted image having a smaller volume between the two converted images is selected as the final compressed image, or the converted image having a smaller volume of the compressed image between two converted images is selected as the final compressed image.

Therefore, according to the operations of the image compression unit 2000, the compression is performed in a different manner according to the presence of compression and the presence of loss if compressed, and the compression is performed according to a plurality of compression techniques even in the same category so as to select the compressed image which is more optimized, thereby providing the compression which is more efficient and minimizes the deterioration of image quality with respect to each image.

More preferably, the compression method of the compressed image in the image compression unit 2000 is the same as the compressing manner of the preprocessed image or the original image. In other words, when the preprocessed image or original image is a lossy compressed image, the image conversion is performed on the preprocessed image or the original image in the manners A and B. In the case that the image having a smaller volume is selected as the final compressed image after the re-compression is performed again, the compression method upon the re-compression is desirable to perform the lossy compression which is the original compression type of the preprocessed image or original image.

In addition, according to an embodiment of the present invention, when performing compression according to a plurality of compression techniques in the category, the compression is not performed according to the same algorithm over the entire area of the image, but the compression is optimally performed for each image block by determining characteristics for each image block, so that more optimal compression can be performed for each compression technique.

Preferably, the image conversion unit 2300 determines the complexity or the number of colors of the image block of the preprocessed image, such that a different image processing is performed for each image block. The image conversion unit 2300 includes a complexity determination unit for determining the complexity and/or a color number determination unit for determining the number of colors (not shown).

The complexity determination unit calculates the image complexity for the image block constituting the image or the local area constituting the image. The complexity of image (image complexity) herein refers to the degree of change of the image.

Preferably, the complexity determination unit specifically includes at least one of a pixel value determination unit, a color number determination unit, and a quantization determination unit. Meanwhile, the complexity determination unit may determine the complexity by using one of the pixel value determination unit, the color number determination unit, and the quantization determination unit, or may determine the complexity based on at least two determination results.

Meanwhile, the color number determination unit is the same as the color number determination unit included in the complexity determination unit.

The pixel value determination unit converts the image block constituting the image or the local area constituting the image into a gray image, and measures a changed amount of the pixel value, thereby calculating the image complexity. Herein, the gray image refers to an image expressed only by brightness information, in other words, information about brightness and darkness. In general, a gray level representing the gray image has 28 (=256) levels. When the gray level is closer to 0, the image is dark, and when closer to 255, the image is bright.

The pixel value determination unit may obtain a difference (differential value) between a predetermined pixel value and that of pixel in each image block constituting the image converted into the gray image or the pixel in the local area constituting the image, calculate a changed amount obtained by calculating an average of differences of pixel values, and determine whether the changed amount is equal to or greater than a preset value.

The high average of the differential values signifies that the image complexity corresponding to a portion of the image block constituting the image converted into the gray image or the local area constituting the image is high. Herein, the pixel value determination unit determines that the image complexity is high when the changed amount is equal to or greater than the preset value with respect to the image block constituting the image converted into the gray image or the local area constituting the image. On the contrary, it is determined that the image complexity is low when the changed amount is less than the preset value.

The color number determination unit measures the number of colors with respect to the image block constituting the image or the local area constituting the image, thereby calculating the image complexity. Particularly, the color number determination unit may determine whether the number of colors with respect to the image block constituting the image or the local area constituting the image is equal to or greater than a predetermined number of colors, thereby calculating the image complexity. Herein, the color number determination unit determines that the image complexity is high when the number of colors is equal to or greater than the preset reference color number (Nc_standard) with respect to the image block constituting the image or the local area constituting the image. On the contrary, it is determined that the image complexity is low when the number of colors is equal to or less than the preset reference color number (Nc_standard).

The quantization determination unit quantizes the image block constituting the image or the local area constituting the image based on a predetermined quantization level, and measures an overall distribution of the quantization level based on a corresponding histogram, thereby calculating the image complexity. To this end, firstly, the quantization determination unit quantizes the image block constituting the image or the local area constituting the image, thereby generating a quantized image. When the quantization is performed, values of pixels for the image block constituting the image or for local areas constituting the image are set with 2n quantization levels of integer values such as 0, 1, 2, . . . , and 2n−1.

The quantization identification value is based on the median on the histogram. For example, in the case of quaternary quantization, it is assumed that histogram values are based on 25%, 50%, and 75%. Meanwhile, the histogram is a graph showing a frequency distribution, and shows as a column shape so that distribution features of the observed data are viewed at a glance. The histogram may also be referred to as a column graph, a picture-shape drawing or the like. Herein, the quantization levels are displayed on a horizontal axis of the histogram at predetermined intervals, and the frequencies of pixels distributed at each quantization level (hereinafter referred to as “the number of pixels”) are displayed on the vertical axis at a predetermined intervals. In other words, the histogram is expressed by a column having a height proportional to the number of pixels corresponding to each section between the quantization levels.

The quantization determination unit may analyze the histogram showing the result of quantizing each image block constituting the image or the local area constituting the image, obtain an average value of the quantization levels, and determined whether the number of pixels deviating from a predetermined range to have the average value of the quantization levels (deviating from the average value of the quantization levels) is equal to or greater than a predetermined number, thereby calculating the image complexity.

For example, the quantization determination unit may determine that the image complexity is high when the number of pixels deviating from the average value is 50% or more in the histogram showing the result of quantizing each image block constituting the image or the local area constituting the image.

FIG. 6 is a view schematically showing operations of a file format determination unit 2100 according to an embodiment of the present invention.

As shown in FIG. 6, the file format determination unit 2100 determines whether a file format of the preprocessed image or the original image is a lossy compressed image, a lossless compressed image, or an uncompressed image. In other words, the presence of compression of the image and the type of the compression are determined, and the image conversion unit 2300 performs the image compression in a different manner according to the determination result of the file format determination unit 2100.

FIGS. 7A, 7B and 7C are views illustrating image blocks according to an embodiment of the present invention.

FIG. 7A shows an example in which the original image or the preprocessed image is divided into 2×2 image blocks, FIG. 7B shows an example in which the original image or the preprocessed image is divided into 4×4 image blocks, and FIG. 7C shows an example in which the original image or the preprocessed image is divided into 8×8 image blocks.

The division manner for the image blocks of the present invention is not limited to 7A, 7B and 7C, but may be set in various forms. In addition, the image blocks divided by the image block division unit 2200 may not be formed to have a fixed pattern and may be set based on a different reference for each area.

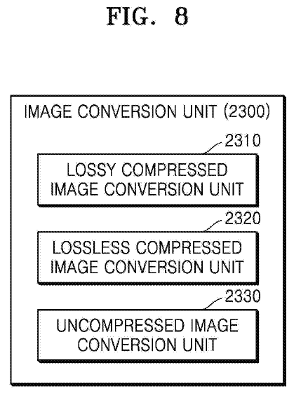

FIG. 8 is a view schematically showing an internal configuration of an image conversion unit 2300 according to an embodiment of the present invention. The image compression unit 2000 determines whether a file format of the preprocessed image corresponds to a lossy compressed image, a lossless compressed image, or an uncompressed image, and the image conversion unit 2300 converts the preprocessed image in a different manner according to the file format.

In other words, the image conversion unit 2300 includes a lossy compressed image conversion unit 2310, a lossless compressed image conversion unit 2320, and an uncompressed image conversion unit 2330 which perform different manners, respectively. The lossy compressed image conversion unit 2310, the lossless compressed image conversion unit 2320, and the uncompressed image conversion unit 2330 may compress images in different manners. However, in another embodiment of the present invention, for example, both conversion units may compress images in the same manners. For example, the lossy compressed image conversion unit 2310 and the lossless compressed image conversion unit 2320 may compress images in the same manner, and the uncompressed image conversion unit 2330 may compress images in a different manner.

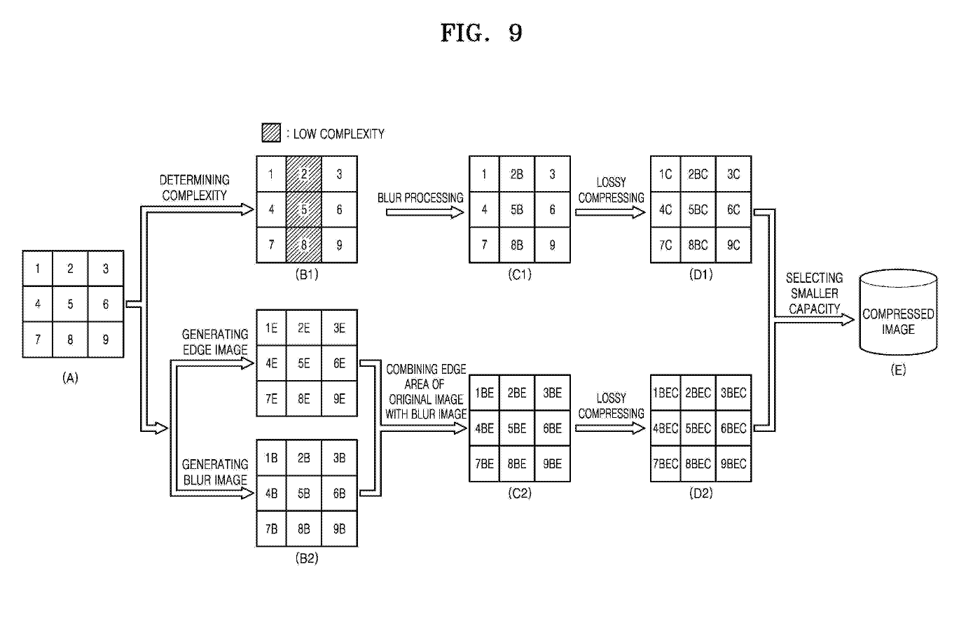

FIG. 9 is a view schematically showing operations of the image conversion unit 2300 in the case of a lossy compressed image according to an embodiment of the present invention.

Herein, the operation of the image conversion unit 2300 refers to the operation of the lossy compressed image conversion unit 2310. Preferably, when the preprocessed image or the original image is a lossy compressed image, at least two converted images are generated by converting the preprocessed image or the original image by using at least two manners, at least two compressed images are generated by performing the lossy compression on the converted image, and the image having a smaller volume between the at least two compressed images is selected as a final compressed image.

Preferably, the image conversion unit 2300 determines the complexity of the image block of the preprocessed image or the original image, generates a first conversion image by blur-processing each image block according to the complexity, blur-processes the preprocessed image or the original image, extracts an edge area of the preprocessed image or the original image, and combines the original area of the preprocessed image or the original image to an area corresponding to the edge area of the preprocessed image or the original image which is blur-processed, thereby generating a second conversion image.

Then, the image conversion unit 2300 may select or output an image having a smaller capability between the first converted image and the second converted image as a final compressed image; or compress the first converted image and the second converted image, and select or output an image having a smaller capability between the first compressed image and the second compressed image, which are compressed, as a final compressed image; or compress the first converted image and the second converted image, and select or output the first converted image as the final compressed image when the first compressed image has a smaller capability between the first compressed image and the second compressed image which are compressed, or select or output the second converted image as the final compressed image when the second compressed image has a smaller volume.

Hereinafter, an embodiment of the present invention will be described in more detail.

In FIG. 9, A shows the preprocessed image or the original image divided into nine image blocks.

In FIG. 9, B1 to D1 show a process of converting the lossy compressed image in the first manner. Specifically, in B1 of FIG. 9, the complexity of the image block of the preprocessed image or the original image is determined. The determination of the complexity is the same as the determination in the above-described complexity determination unit.

For example, in B1 of FIG. 9, it is determined that the complexities of the image blocks at (2, 1), (2, 2), and (2, 3) is lower than the preset reference.

Then, the image conversion unit 2300 blur-processes the image blocks at (2, 1), (2, 2), and (2, 3). “B” is marked for the blur-processed image block (C1 in FIG. 9).

Then, the image conversion unit 2300 lossy-compresses the entire image.

In FIG. 9, D1 shows the image which is lossy-compressed.

In FIG. 9, B2 to D2 shows a process of converting the lossy compressed image in the second manner. Specifically, B2 of FIG. 9, shows that generating an edge image by performing binarization from the preprocessed image or the original image, and shows two images obtained by blur-processing the entire preprocessed image or original image.

Then, the image conversion unit 2300 sets the blur-processed image (lower image) as a default, and synthesizes an area of the original image (the preprocessed image or the original image) corresponding to the edge area read from the edge image (C2 of FIG. 9).

Then, the image conversion unit 2300 lossy-compresses the entire image. In FIG. 9, D2 shows the image which is lossy-compressed.

More specifically, the edge image refers to an image obtained by calculating an edge which is an edge area corresponding to a high frequency area with respect to an image. More preferably, the image conversion unit 2300 generates an edge binarization image by binarizing the edge image. At this time, the pixel value of each pixel of the edge binarization image may be 0 (black) or 1 (white).

Then, the image conversion unit 2300 synthesizes the original image area, which corresponds to a pixel having a value of 0 in the edge image generated by the binarized image generation unit, with the blur-processed image.

Then, the image conversion unit 2300 may compare the capacities between the first compressed image shown in D1 of FIG. 9 and the second compressed image shown in D2 of FIG. 9, and select or output the image having a smaller volume therebetween as the final compressed image.

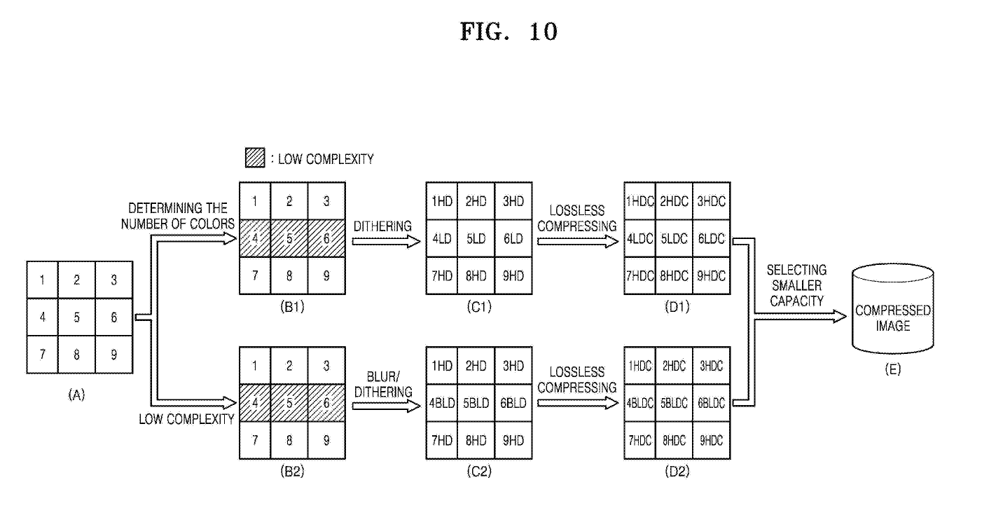

FIG. 10 is a view schematically showing operations of the image conversion unit 2300 in the case of a lossless compressed image according to an embodiment of the present invention.

Herein, the operation of the image conversion unit 2300 refers to the operation of the lossless compressed image conversion unit 2320.

Preferably, when the preprocessed image is a lossless compressed image, at least two converted images are generated by converting the preprocessed image by using at least two manners, at least two compressed images are generated by performing the lossless compression on the converted image, and the image having a smaller volume between the at least two compressed images is selected as a final compressed image.

Preferably, the image compression unit 2000 determine the number of colors for each image block of the preprocessed image, and performs a different dithering processing for each image block according to the number of colors, thereby generating a first converted image; and the image compression unit 2000 determines the complexity for each image block of the preprocessed image, and performs a different dithering processing and a blur-processing for each image block according to the complexity, thereby generating the second converted image.

Herein, the dithering processing refers to an image processing which compensates for defects due to differences in a color space of an image, and serves to convert an image into an image having a smaller number of colors than that of the original image. More specifically, an image block having the number of colors less than a predetermined first color number (Nc_1), is dithering processed to have the number of bits smaller than the preset number of bit (for example, 7, 8, 9, 12, or 15 bits when the number of bits of the original image is 24 bits and the preset number of bits is 16 bits). An image block having the number of colors equal to or greater than the preset second number of color number (Nc_2; Nc_2>=Nc_1, Nc_2 is equal to or smaller than the total number of colors of the original image) is dithering processed to have the number of bits greater than the preset number of bit (for example, 18, or 21 bits when the number of bits of the original image is 24 bits and the preset number of bits is 16 bits), thereby generating the second converted image.

More preferably, sections are set according to the number of colors, and different dithering is performed for each section. High-bit dithering is performed for the section having the greater number of color, low-bit dithering is performed for the section having the smaller number of color, and the dithering may not be performed for the section having the remarkably greater number of colors. For example, 8-bit dithering is performed in the section between N1 and N2 having the smaller number of colors of (first section), 16-bit dithering is performed in the section between N2 and N3 (second section), 24-bit dithering is performed in the section between N3 and N4 (third section), and dithering may not be performed in section of N4 or more (fourth section).

Then, the image conversion unit 2300 may select or output an image having a smaller capability between the first converted image and the second converted image as a final compressed image; or compress the first converted image and the second converted image, and select or output an image having a smaller capability between the first compressed image and the second compressed image, which are compressed, as a final compressed image; or compress the first converted image and the second converted image, and select or output the first converted image as the final compressed image when the first compressed image has a smaller capability between the first compressed image and the second compressed image which are compressed, or select or output the second converted image as the final compressed image when the second compressed image has a smaller volume.

Hereinafter, an embodiment of the present invention will be described in more detail.

In FIG. 10, A shows the preprocessed image divided into nine image blocks.

In FIG. 10, B1 to D1 show a process of converting the lossless compressed image in the first manner. Specifically, in B1 of FIG. 10, the number of colors of the image block of the preprocessed image is determined. The determination of the number of colors is the same as the determination in the above-described color number determination unit.

For example, in B1 of FIG. 10, it is determined that the numbers of colors of the image blocks at (1, 2), (2, 2), and (3, 2) is smaller than the preset reference.

Then, the image conversion unit 2300 dithering processes the image blocks at (2, 1), (2, 2), and (2, 3) with a lower bit number, and high-bit dithering is performed for the remaining image blocks. Alternatively, in another embodiment of the present invention, the dithering processing is not performed on the image block having the remarkably greater number of colors. “HD” is marked for the image block on which high-bit dithering processing is performed, and “LD” is marked for the image block on which low-bit dithering processing is performed (C1 of FIG. 10).

Then, the image conversion unit 2300 lossless-compresses the entire image. In FIG. 10, D1 shows the image which is lossless-compressed.

In FIG. 10, B2 to D2 show a process of converting the lossless compressed image in the second manner.

Specifically, in B2 of FIG. 10, the complexity of the image block of the preprocessed image is determined. The determination of the complexity is the same as the determination in the above-described complexity determination unit.

For example, in B1 of FIG. 10, it is determined that the numbers of colors of the image blocks at (1, 2), (2, 2), and (3, 2) is smaller than the preset reference.

Then, the image conversion unit 2300 dithering processes the image blocks at (1, 2), (2, 2), and (3, 2) with the smaller bit number after blur-processing, and high-bit dithering is performed for the remaining image blocks. Alternatively, in another embodiment of the present invention, the dithering processing is not performed on the image block having the remarkably greater number of colors. “B” is marked for the blur-processed image block, “HD” is marked for the image block on which high-bit dithering processing is performed, and “LD” is marked for the image block on which low-bit dithering processing is performed (C2 of FIG. 10).

Then, the image conversion unit 2300 lossless-compresses the entire image. In FIG. 10, D2 shows the image which is lossless-compressed.

Then, the image conversion unit 2300 may compare the capacities between the first compressed image shown in D1 of FIG. 10 and the second compressed image shown in D2 of FIG. 10, and select or output the image having a smaller volume therebetween as the final compressed image.

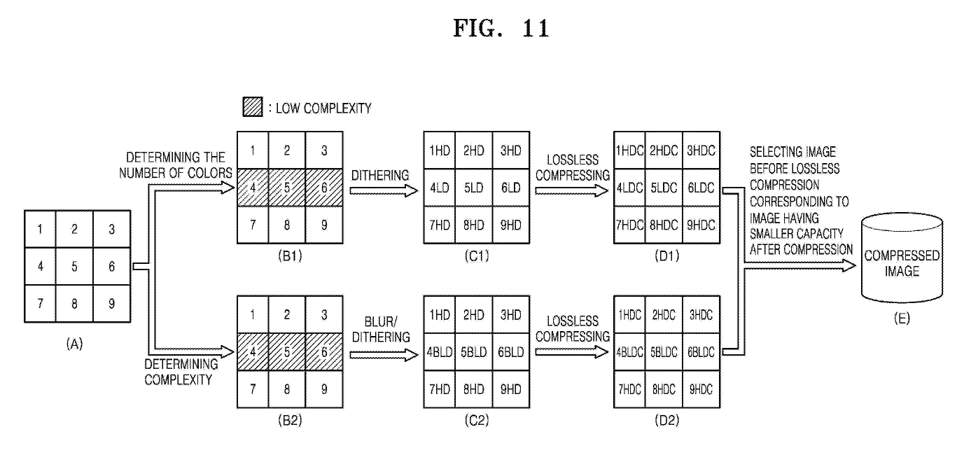

FIG. 11 is a view schematically showing operations of the image conversion unit 2300 in the case of an uncompressed image according to an embodiment of the present invention.

Herein, the operation of the image conversion unit 2300 refers to the operation of the uncompressed image conversion unit 2330.

Preferably, when the preprocessed image is an uncompressed image, the preprocessed image is converted by using at least two so as to generate at least two converted images and lossless compression is performed on the converted images so as to generate at least two compressed images. In addition, the converted image having a smaller volume of the compressed image between converted images is selected as the final compressed image.

Preferably, the image compression unit 2000 determines the number of colors for each image block of the preprocessed image, and performs a different dithering processing for each image block according to the number of colors, thereby generating a first converted image; and the image compression unit 2000 determines the complexity for each image block of the preprocessed image, and performs a different dithering processing and a blur-processing for each image block according to the complexity, thereby generating the second converted image.

Then, the image conversion unit 2300 may select or output an image having a smaller capability between the first converted image and the second converted image as a final compressed image; or compress the first converted image and the second converted image, and select or output an image having a smaller capability between the first compressed image and the second compressed image, which are compressed, as a final compressed image; or compress the first converted image and the second converted image, and select or output the first converted image as the final compressed image when the first compressed image has a smaller capability between the first compressed image and the second compressed image which are compressed, or select or output the second converted image as the final compressed image when the second compressed image has a smaller volume.

In addition, the image conversion unit 2300 may compress the first converted image and the second converted image, and select or output the first converted image as the final compressed image when the first compressed image has a smaller capability between the first compressed image and the second compressed image which are compressed. Alternatively, when the second compressed image has a smaller volume, in the case that the second converted image is selected or outputted as the final compressed image, the final compressed image can be outputted as an uncompressed image the same as the original image, and the above uncompressed image can further reduce the overall capability when the entire compression or the like is performed later.

Hereinafter, an embodiment of the present invention will be described in more detail.

In FIG. 11, A shows the preprocessed image divided into nine image blocks.

In FIG. 11, B1 to D1 show a process of converting the lossless compressed image in the first manner.

Specifically, in B1 of FIG. 11, the number of colors of the image block of the preprocessed image is determined. The determination of the number of colors is the same as the determination in the above-described color number determination unit.

For example, in B1 of FIG. 11, it is determined that the numbers of colors of the image blocks at (1, 2), (2, 2), and (3, 2) is smaller than the preset reference.

Then, the image conversion unit 2300 dithering processes the image blocks at (2, 1), (2, 2), and (2, 3) with a lower bit number, and high-bit dithering is performed for the remaining image blocks. Alternatively, in another embodiment of the present invention, the dithering processing is not performed on the image block having the remarkably greater number of colors. “HD” is marked for the image block on which high-bit dithering processing is performed, and “LD” is marked for the image block on which low-bit dithering processing is performed (C1 of FIG. 11).

Then, the image conversion unit 2300 lossless-compresses the entire image. In FIG. 11, D1 shows the image which is lossless-compressed.

In FIG. 11, B2 to D2 show a process of converting the lossless compressed image in the second manner. Specifically, in B2 of FIG. 11, the complexity of the image block of the preprocessed image is determined. The determination of the complexity is the same as the determination in the above-described complexity determination unit.

For example, in B1 of FIG. 11, it is determined that the numbers of colors of the image blocks at (1, 2), (2, 2), and (3, 2) is smaller than the preset reference.

Then, the image conversion unit 2300 dithering processes the image blocks at (1, 2), (2, 2), and (3, 2) with the smaller bit number after blur-processing, and high-bit dithering is performed for the remaining image blocks. Alternatively, in another embodiment of the present invention, the dithering processing is not performed on the image block having the remarkably greater number of colors. “B” is marked for the blur-processed image block, “HD” is marked for the image block on which high-bit dithering processing is performed, and “LD” is marked for the image block on which low-bit dithering processing is performed (C2 of FIG. 11).

Then, the image conversion unit 2300 lossless-compresses the entire image. In FIG. 11, D2 shows the image which is lossless-compressed.

Then, the image conversion unit 2300 may compare the capacities between the first compressed image shown in D1 of FIG. 11 and the second compressed image shown in D2 of FIG. 11, and the converted image having a compressed image with a smaller volume may be selected or outputted as the final compressed image.

Document Image Optimization Method

Hereinafter, a method of optimizing an image will be described according to the present invention.

The method of optimizing an image according to the present invention may be performed by the device for optimizing an image as described with reference to FIGS. 2 to 11. Accordingly, some of the redundant description of the device for optimizing an image will be omitted.

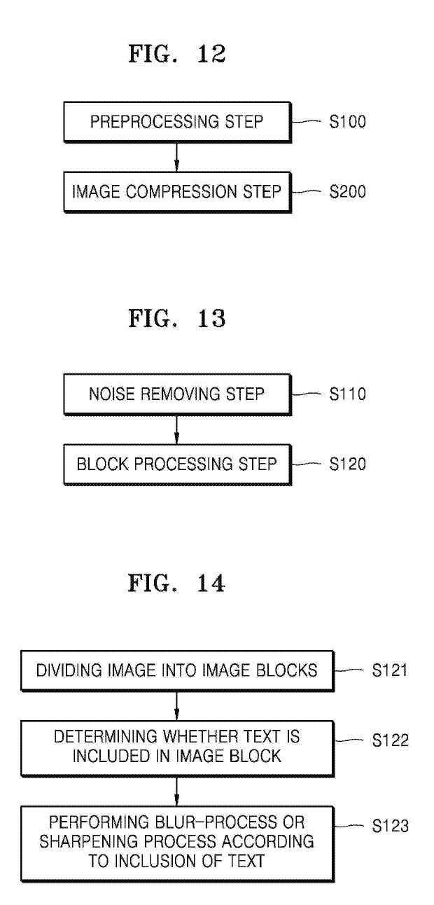

FIG. 12 is a view schematically showing steps of a method for optimizing a document image according to an embodiment of the present invention.

According to the embodiment, a preprocessing step (S100) of generating a preprocessed image by removing noise from an original image and sharpening a text is performed. In the preprocessing step, at least one of sharpening processing, binarizing processing, and blurring processing may be performed among image processing techniques. The preprocessing step S100 is performed, so that the original image may be converted into the preprocessed image, and the preprocessed image may be increased in sharpness of the text in a document image.

In addition, the method of optimizing a document image according to the present invention may further include an image compression step S200 of performing an image compression on the preprocessed image. In this case, additional image processing, in other words, image compression is performed on the preprocessed image, so that the volume of the document image may be reduced.

Preferably, in the image compression step S200, compression is performed by using different manners depending on whether the preprocessed image is compressed and whether the preprocessed image is lossy if compressed. Herein, whether the preprocessed image is compressed and whether the preprocessed image is lossy if compressed is basically determined according to whether the original image is compressed and whether the original image is lossy if compressed. In the above manner, optimization can be performed as a document image with respect to each different type of original image without changing the file format of the original image.

In addition, the compression is performed with considering whether the original image is compressed and whether the original image is lossy if compressed, so that the volume can be reduced while minimizing an image quality degradation of the original image or the preprocessed image.

In addition, because the image compression step S200 is performed after the preprocessing step S100 is performed, the image can be optimized while maintaining the effect in the image compression step S200.

FIG. 13 is a view schematically showing sub steps of a preprocessing step according to an embodiment of the present invention.

As shown in FIG. 13, the preprocessing step (S100) include: a noise removing step S110 of performing a sharpening process and a binarizing process on the original image; and a block processing step S120 of dividing the original image subjected to the noise removal step (S110) into image blocks, and performing different processes with respect to an image block including a text and an image block not including a text.

Preferably, in the noise removing step (S110), the sharpening process is performed on the original image in advance, and then performs the binarizing process on the original image in the adaptive threshold manner.

Preferably, in the block processing step (S120), the original image is primarily divided into image blocks. As shown in 7A, 7B and 7C, the image block refers to each image defined by a plurality of block areas. Meanwhile, after the image is divided into image blocks, a feature of each image block is distinguished, and different image processing may be performed for each of the image blocks according to the distinguished result.

FIG. 14 is a view schematically showing sub steps of a block processing step S120 according to an embodiment of the present invention.

Preferably, in the embodiment, the block processing step (S120) include: a preprocessing image block division step (S121) of dividing an image into image blocks; a text inclusion determination step (S122) of determining whether a text is included in the divided image blocks; and a blur/sharpen processing step S123 of performing a blur-process or a sharpening process according to inclusion of a text. As shown in 7A, 7B and 7C, the image block refers to each image defined by a plurality of block areas. Meanwhile, after the image is divided into image blocks, a feature of each image block is distinguished, and different image processing may be performed for each of the image blocks according to the distinguished result.

Preferably, in the block processing step (S120), the inclusion of text in each image block is determined.

In order to determine whether the text is included, the black pixel density of the image block is measured, and it is determined as an image block including the text when the image block has high density of the black pixel. Alternatively, adjacent pixel groups continuously connected in the image block are labeled, and a straight linear length or a diagonal length of the labeled group is measured, such that the presence of text is determined based on a histogram for the length; a text extraction algorithm is performed on the image block to determine whether the text is extracted; or a statistical histogram for the image block is outputted to determine the similarity with the histogram when the text is included.

Then, in the block processing unit 1200, the sharpening-process is performed on the image block including the text, and the blur-process is performed on the image blocks not including the text.

According to the above configuration, blur-process or sharpening process are additionally performed for each area defined as the image block with respect to the entirely shaded and binarized original image. Accordingly, when image block contains a text, sharpening process, binarizing process, sharpening process are sequentially performed. When image block does not contain a text, sharpening process, binarizing process, blur-process are sequentially performed. As described above, one image is divided into image blocks, and different additional image processing is performed depending on whether text is included in each image block, so that the document image can be converted more clearly, and the volume of the image can be reduced in the image compression step S200, which will be described later, without deteriorating the quality.

Image Compression Method

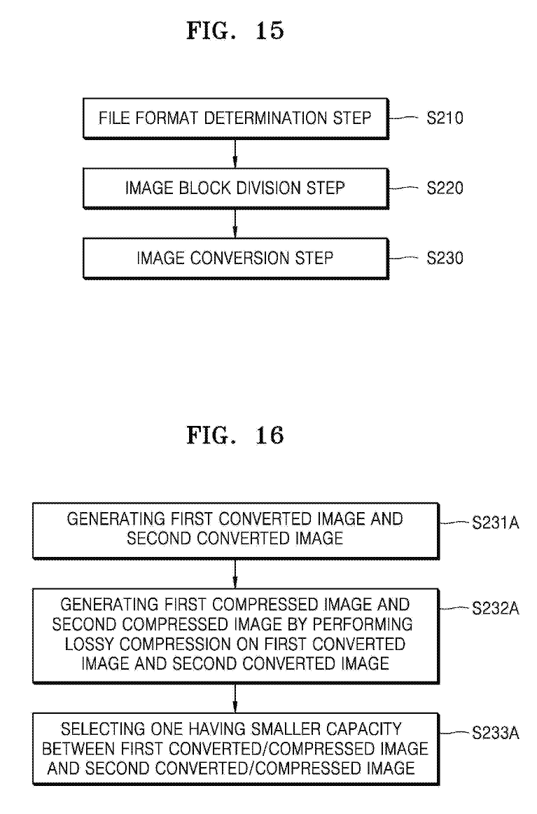

FIG. 15 is a view schematically showing sub steps of an image compression step S200 according to an embodiment of the present invention. For convenience, hereinafter, the operations of the image compression step will be described as a subsequent process of the preprocessed image preprocessed in the preprocessing step. However, the present invention is not limited thereto, and includes an embodiment in which the image is independently compressed in the image compression step S200 with respect to an image to which the preprocessing is not performed (hereinafter referred to as “original image” for convenience).

In the image compression step S200, operations of optimizing the volume of the image are performed while minimizing the deterioration of image quality in the preprocessed image or the original image preprocessed in the preprocessing step S100.

Specifically, the image compression step S200 includes: a file format determination step S210 of determining whether a file format of the preprocessed image or the original image is a lossy compressed image, a lossless compressed image, or an uncompressed image; an image block division step S220 of dividing the preprocessed image or the original image into a plurality of image blocks; and an image conversion step S230 of converting the preprocessed image or the original image in a different manner according to file formats of the preprocessed image.

Accordingly, in the image compression step S200, the conversion (compression) is not performed in the same manner for all preprocessed images or original images, but whether the preprocessed image or the original image is compressed, and whether the preprocessed image or the original image is lossy if compressed are determined, and accordingly the preprocessed image or original image is converted in a different manner according to the determination, so that each image can be individually optimized. Herein, the presence of compression of the preprocessed image or the original image and the presence of loss if compressed is usually determined by the original image.

In addition, in the image compression step S200, the image conversion is not performed in the same way for the entire area of the image when the image conversion is performed, but the image is divided into a plurality of image blocks, and the image conversion is performed in a different way according to characteristics of each image block, so that each image can be converted in a manner optimized for each portion of the image block.

More preferably, in the image compression step S200, the conversion is performed by using at least two different manners depending on whether the preprocessed image or the original image is compressed and whether the preprocessed image or the original image is lossy if compressed, and one of the at least two converted images may be selected as a final compressed image, or one of at least two compressed images of the at least two converted images is selected as a final compressed image.

For example, in the image compression step S200, when the image is a lossy compressed image, the image is converted by using a method A and a method B, when the image is a lossless compressed image, the image is converted by using a method C and a method D, and when the image is an uncompressed image, the image is converted by using a method E and a method F.

Then, the compressed image having a smaller volume between the two compressed images subjected to the lossy or lossless compression again with respect to the images converted in two manners is selected as the final compressed image; the converted image having a smaller volume between the two converted images is selected as the final compressed image; or the converted image having a smaller volume of the compressed image between two converted images is selected as the final compressed image.

Therefore, according to the operations of the image compression step S200, the compression is performed in a different manner according to the presence of compression and the presence of loss if compressed, and the compression is performed according to a plurality of compression techniques even in the same category so as to select the compressed image which is more optimized, thereby providing the compression which is more efficient and minimizes the deterioration of image quality with respect to each image.

More preferably, in the image compression step S200, the compression method of the compressed image is the same as the compressing manner of the preprocessed image or the original image.

In other words, when the preprocessed image or original image is a lossy compressed image, the image conversion is performed on the preprocessed image or the original image in the manners A and B. In the case that the image having a smaller volume is selected as the final compressed image after the re-compression is performed again, the compression method upon the re-compression is desirable to perform the lossy compression which is the original compression type of the preprocessed image or original image.

In addition, according to an embodiment of the present invention, when performing compression according to a plurality of compression techniques in the category, the compression is not performed according to the same algorithm over the entire area of the image, but the compression is optimally performed for each image block by determining characteristics for each image block, so that more optimal compression can be performed for each compression technique.

Preferably, in the image conversion step, the complexity or the number of colors of the image block of the preprocessed image or the original image is determined, so that a different image processing is performed for each image block. The image conversion step S230 includes a complexity determination step of determining the complexity and/or a color number determination step of determining the number of colors (not shown).

In the complexity determination step, the image complexity for the image block constituting the image or the local area constituting the image is calculated. The complexity of image (image complexity) herein refers to the degree of change of the image.

FIG. 16 is a view schematically showing sub steps of an image conversion step S230 in the case of a lossy compressed image according to an embodiment of the present invention.

The description thereof will be omitted because it is partially duplicated in the description of FIG. 9.

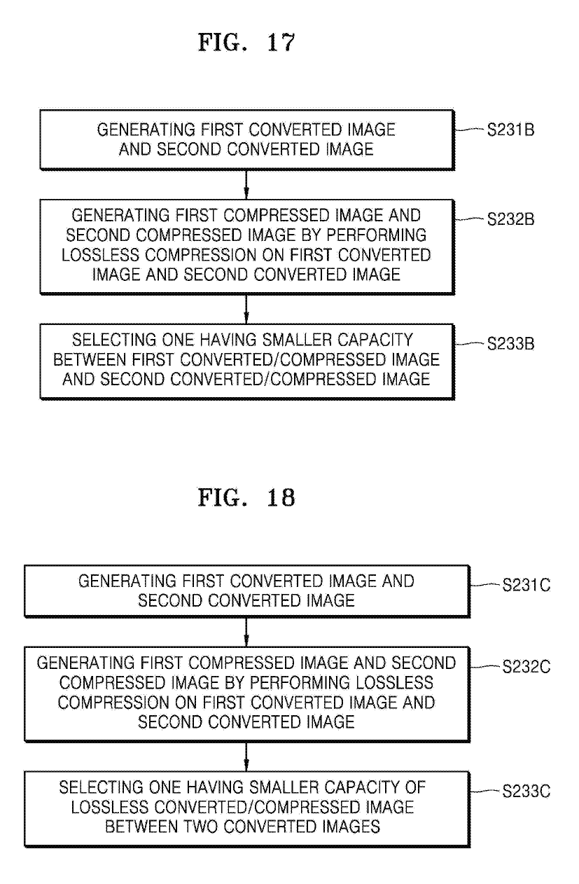

FIG. 17 is a view schematically showing sub steps of an image conversion step S230 in the case of a lossless compressed image according to an embodiment of the present invention.

The description thereof will be omitted because it is partially duplicated in the description of FIG. 10.

FIG. 18 is a view schematically showing sub steps of an image conversion step S230 in the case of an uncompressed image according to an embodiment of the present invention.

The description thereof will be omitted because it is partially duplicated in the description of FIG. 11.

What is claimed is:

1. A method of compressing an image implemented by a computing device, the method comprising:
a file format determination step of determining whether a file format of an original image is a lossy compressed image, a lossless compressed image, or an uncompressed image;
an image block division step of dividing the original image into a plurality of image blocks; and
an image conversion step of converting the original image in a different manner according to the file format of the original image.

2. The method of claim 1, wherein the image conversion step comprises:
converting the original image by using at least two different manners according to whether the original image is compressed and whether the original image is lossy upon compression; and
selecting one of the at least two converted images as a final compressed image, or selecting one of at least two compressed images of the at least two converted images as a final compressed image.

3. The method of claim 2, wherein the compression method for the compressed image in the image conversion step corresponds to the compression method for the original image.

4. The method of claim 1, wherein the image conversion step comprises performing a different image processing for each image block by determining complexity or a number of colors of the image block of the original image.

5. The method of claim 1, wherein, when the original image is the lossy compressed image or the lossless compressed image, the image conversion step comprises:
generating at least two converted images by converting the original image by using at least two manners;
generating at least two compressed images by performing lossy or lossless compression on the converted images; and
selecting an image having a smaller volume between the at least two compressed images as a final compressed image.

6. The method of claim 1, wherein, when the original image is the uncompressed image, the image conversion step comprises:
generating at least two converted images by converting the original image by using at least two manners;
generating at least two compressed images by performing lossless compression on the converted images; and
selecting a corresponding compressed image having a smaller volume between the at least two converted images as a final compressed image.

7. The method of claim 1, wherein, when the original image is the lossy compressed image, the image conversion step comprises:
determining complexity for each image block of the original image; and
generating a first converted image by performing blur-processing for each image block according to the complexity.

8. The method of claim 1, wherein, when the original image is the lossy compressed image, the image conversion step comprises:
performing blur-processing on the original image;
extracting an edge area of the original image; and
generating a second converted image by combining an original area of a preprocessed image with an area corresponding to the edge area in the original image which is blur-processed.

9. The method of claim 1, wherein, when the original image is the lossy compressed image, the image conversion step comprises:
determining complexity for each image block of the original image;
generating a first converted image by performing blur-processing for each image block according to the complexity;
performing blur-processing on the original image;
extracting an edge area of the original image;
generating a second converted image by combining an original area of the preprocessed image with an area corresponding to the edge area in the original image which is blur-processed; and
determining one of the first converted image and the second converted image or one compressed image as a final compressed image.

10. The method of claim 1, wherein, when the original image is the lossless compressed image or the uncompressed image, the image conversion step comprises:
determining a number of colors for each image block of the original image; and
generating a first converted image by performing a different dithering processing for each image block according to the number of colors.

11. The method of claim 1, wherein, when the original image is the lossless compressed image or the uncompressed image, the image conversion step comprises:
determining complexity for each image block of the original image; and
generating a second converted image by performing a different dithering processing and a blur-processing for each image block according to the complexity.

12. The method of claim 1, wherein, when the original image is the lossless compressed image or the uncompressed image, the image conversion step comprises:
determining a number of colors for each image block of the original image;
generating a first converted image by performing a different dithering processing for each image block according to the number of colors;
determining complexity for each image block of the original image, and
generating a second converted image by performing a different dithering processing and a blur-processing for each image block according to the complexity; and
determining one of the first converted image and the second converted image or one compressed image as a final compressed image.

13. The method of claim 1, the image conversion step comprises:
determining complexity for each image block of the original image; and
performing a different image processing for each image block according to the complexity, when the original image is the lossy compressed image, and
determining the number of colors for each image block of the original image; and
performing a different image processing for each image block according to the number of colors, when the original image is the lossless compressed image or the uncompressed image.

14. A computer-readable medium configured to store instructions for allowing a computing device to perform the following steps comprising:
a file format determination step of determining whether a file format of an original image is a lossy compressed image, a lossless compressed image, or an uncompressed image;
an image block division step of dividing the original image into a plurality of image blocks; and
an image conversion step of converting the original image in a different manner according to the file format of the original image.

15. A computing device including at least one processor and at least one memory to compress an original image, the computing device comprising:
a file format determination unit for determining whether a file format of an original image is a lossy compressed image, a lossless compressed image, or an uncompressed image;
an image block division unit for dividing the original image into a plurality of image blocks; and
an image conversion unit for converting the original image in a different manner according to the file format of the original image.
